(19) United States
(12) Patent Application Publication
(10) Pub. No.: US 2015/0039493 A1
(43) Pub. Date: Feb. 5, 2015

(54) INTELLIGENT BUSINESS MANAGEMENT PLATFORM METHOD AND APPARATUS

(71) Applicant: MASTERCARD INTERNATIONAL INCORPORATED, Purchase, NY (US)

(72) Inventors: Richard Crum, Weston, CT (US); John Gander, McLean, VA (US)

(73) Assignee: MASTERCARD INTERNATIONAL INCORPORATED, Purchase, NY (US)

(21) Appl. No.: 13/955,838

(22) Filed: Jul. 31, 2013

(51) Int. Cl. G06Q 20/40; G06Q 20/34

(52) U.S. Cl. CPC G06Q 20/405; G06Q 20/34
USPC 705/39

(57) ABSTRACT

A system, method, and computer-readable storage medium configured to enable intelligent management and implementation of travel policies, elite cardholder benefits, or vendor offers related to expenses incurred on a payment card.

### BACKGROUND

1. Field of the Disclosure

Aspects of the disclosure relate in general to financial services. Aspects include an apparatus, system, method and computer-readable storage medium to enable intelligent management of ancillary services related to expenses incurred on a payment card. Other aspects include management of travel and entertainment related services.

2. Description of the Related Art

Many companies issue their employees payment cards, such as credit or debit cards, for use with company business. Such cards offer companies a way to track travel, entertainment, and other company expenses. Companies can use this tracking information to control costs and leverage the information in negotiations with vendors.

Moreover, when company employees pay for business expenses, many companies have policies on the type of expenses that are reimbursable, and may have restrictions on the vendor used. Because of the complexity of some company policies, employees may not realize the policy or about ancillary services related to their company spending—such as preferred company vendors and negotiated rates with the preferred vendors.

However, as these company payment cards rarely offer employees loyalty or rewards for using the cards, employees often shun company cards for personal cards that offer loyalty or rewards points—which defeats the reason companies issue their employees company payment cards in the first place.

### SUMMARY

Embodiments include a system, device, method and computer-readable medium configured to enable intelligent management and implementation of travel policies, elite cardholder benefits, or vendor offers related to expenses incurred on a payment card. A payment network device includes a network interface and a processor. The network interface is configured to receive transaction data regarding a financial transaction, the transaction data including a Primary Account Number and a transaction type. The processor is configured to match the Primary Account Number with an employer from a database, to retrieve an employer policy from the database, to determine whether the employer policy applies to the financial transaction, and to execute the employer policy when the employer policy applies.

### BRIEF DESCRIPTION OF THE DRAWINGS

FIG. 1 illustrates an embodiment of a system configured to enable intelligent management of ancillary services related to expenses incurred on a payment card.

FIG. 2 depicts a block diagram of a payment processor configured to enable intelligent management of ancillary services related to expenses incurred on a payment card.

FIGS. 3A-3B flowchart a method embodiment to enable intelligent management of ancillary services related to expenses incurred on a payment card.

### DETAILED DESCRIPTION

One aspect of the disclosure includes the realization that improving a company cardholder's experience of using a company payment card will increase usage of the card.

Another aspect of the disclosure includes the understanding that analyzing cardholder spending can improve a cardholder's compliance with company policies, and creates opportunities to increase cardholder satisfaction through offering convenience and ancillary services to the cardholder. Ancillary services may include (employer and non-employer) travel policies, elite cardholder policies, and vendor offers.

A further aspect of the disclosure includes analyzing cardholder spending can allow approved or preferred vendors to target offers to cardholders that would enjoy and likely purchase the products or services.

Additionally, another aspect includes the realization that elite cardholders (using elite payment cards) may derive a similar benefit to convenience and ancillary benefits offered to company cardholders. Example of elite payment cards include World™ and World Elite™ branded cards from MasterCard®, trademarks of MasterCard International Incorporated.

Another aspect of the disclosure is not just matching transactions to elite or employer policies and vendor offers, but also the communication of the policy to the cardholder at a relevant time.

These and other aspects may be apparent in hindsight to one of ordinary skill in the art.

Embodiments of the present disclosure include a system, method, and computer-readable storage medium configured to consolidate and redeem electronic vouchers.

Embodiments enable users to intelligent manage of ancillary services related to expenses incurred on a payment card. For the purposes of this disclosure, a payment card includes, but is not limited to: credit cards, debit cards, prepaid cards, electronic checking, electronic wallet, or mobile device payments. In the examples described herein, the payment card may be a company payment card issued specific employee cardholder, or an elite cardholder.

It is further understood by those familiar with the art that cardholders and employers may be required to opt-in, opt-out, or enroll for the features and benefits described herein to comply with legal or regulatory authorities. It is further understood that the opt-in, opt-out, or enrollment may include enrollments based on employer affiliation, elite cardholder status, transaction analysis, and geographic location information provided to a payment processor.

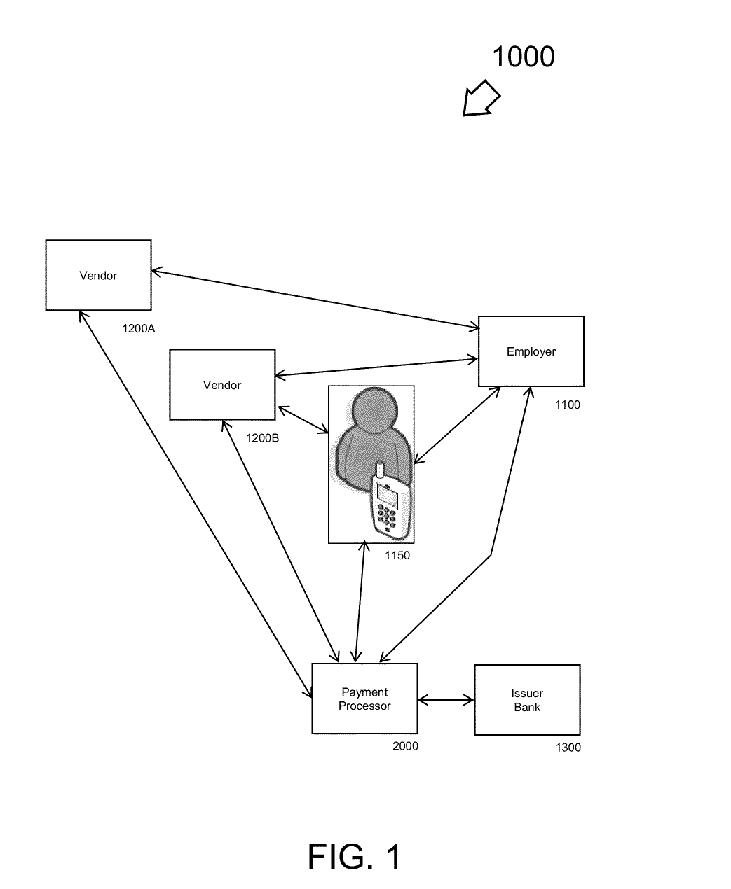

FIG. 1 illustrates an embodiment of a system 1000 configured to enable intelligent management of ancillary services related to expenses incurred on a payment card, constructed and operative in accordance with an embodiment of the present disclosure.

System 1000 includes cardholders using a payment card 1150 issued by their employer 1100 for use at vendors 1200A-B. In alternate embodiments, payment card 1150 may be an elite payment card, as described herein. Whenever a financial transaction occurs at a vendor 1200 using a payment card 1500, the vendor 1200 communicates with payment processor 2000 via a data network to determine the financial worthiness of the cardholder. Additionally, payment processor 2000 may connect in turn to issuer bank 1300. Details and example methods of payment processor 2000 are discussed below.

In embodiments where payment card 1150 is company payment card, employer 1100 is the company, corporation, partnership or other entity that employs cardholder, and provides the payment card 1150 to cardholder to purchase merchandise or services on behalf of the employer 1100.

The vendor 1200A may be hotel, airline, rental car agency, merchant, or other service provider that offers goods or services to cardholders.

An issuer bank 1300 is the institution that provides the credit for the financial payment transaction. Issuer bank 1300 processes data (authorization requests) via the payment processor 2000 and prepares the authorization-formatted response (approvals/declines).

Payment processor 2000 is a payment network capable of processing payments electronically. An example payment processor 2000 includes MasterCard International Incorporated. Payment processor 2000 includes the set of API functions, processes, and data that allow the employer 1100 to input travel and expense policies for cardholder use of payment card 1150. Additionally, payment processor may include API functions, processes, and data that allow vendors 1200 to provide offers, benefits or discounts based at least in part on a cardholder's spending pattern, geographical location, or employer 1100 affiliation.

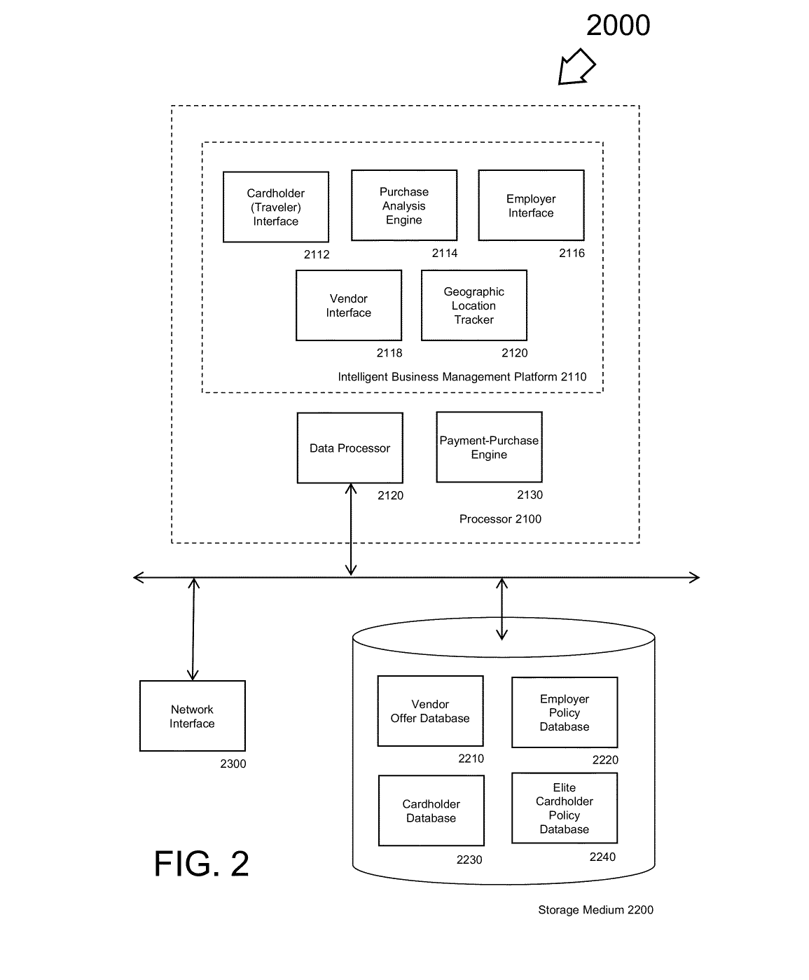

Embodiments will now be disclosed with reference to a block diagram of an exemplary payment processor server 2000 of FIG. 2, constructed and operative in accordance with an embodiment of the present disclosure.

Payment processor server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art.

As shown in FIG. 2, processor 2100 is functionally comprised of a intelligent business management platform 2110, a payment-purchase engine 2130, and a data processor 2120.

Intelligent business management platform 2110 may further comprise: cardholder interface 2112 (sometimes also referred to as a “merchant relationship engine”), purchase analysis engine 2114 (sometimes also referred to as an “upload manager”), employer interface 2116, vendor interface 2118, and geographic location tracker 2120.

Cardholder interface 2112 acts as an interface between cardholder and payment processor to allow cardholders to enter their travel, entertainment, communication, notification preferences and the like. Cardholder interface 2112 also allows cardholder to enroll, opt-in, or opt-out of the service.

Employer interface 2116 facilitates the computerized API interface for entering employer 1100 policies to payment processor server 2000. Employer policies may vary in scope from employer to employer. Example policies include preferred airlines or other vendors, enforcing purchase of economy class airfare, negotiated vendor rate alerts, reminders to “save the receipt” when expenses exceed a predetermined amount, instructions to use public transportation, and any other travel/ entertainment/ purchasing policy known in the art.

Vendor interface 2118 is the API that allows vendors 1200 to communicate special offers and policies for classes of cardholders. Classes may be determined, at least in part, by analysis of cardholder spending, cardholder location, employment status by employer 1100, or cardholder elite status. Certain techniques for identifying particular groups of people using such data are described for example, in U.S. patent application Ser. No. 13/437,987.

Geographical Location Tracker 2120 is the interface that facilitates tracking of a cardholder's geographic location, when approved by the cardholder. The tracking may be based on manual input by the cardholder, analysis of cardholder purchases, or by Global Positioning System (GPS) data provided by cardholder mobile phone or other devices.

Purchase analysis engine 2114 is the portion of the intelligent business management platform 2110 that is configured to analyze cardholder spending. Purchase analysis engine 2114 enables payment processor 2000 to analyze cardholder spending and determine the employer policies and vendor offers available to cardholder. Purchase analysis engine 2114 may analyze and store data related to cardholder payment credit, debit, or charge information in a cardholder database 2230.

Payment-purchase engine 2130 performs payment and purchase transactions, and may do so in conjunction with the embodiments described herein.

Data processor 2120 enables processor 2100 to interface with storage media 3200, network interface 2300 or any other component not on the processor 2100. The data processor 2120 enables processor 2100 to locate data on, read data from, and write data to these components.

These structures may be implemented as hardware, firmware, or software encoded on a computer readable medium, such as storage media 2200. Further details of these components are described with their relation to method embodiments below.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment processor server 2000 to communicate with vendors 1200, cardholders, employers 1100, and/or issuer bank 1300.

Computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage media 2200 may be remotely located from processor 2100, and be connected to processor 2100 via a network such as a local area network (LAN), a wide area network (WAN), or the Internet.

In addition, as shown in FIG. 2, storage media 2200 may also contain a vendor offer database 2210, employer policy database 2220, cardholder database 2230 and an elite cardholder policy database 2240. Vendor offer database 2210 is configured to store available vendor offers. Employer policy database 2220 is configured to store data and policies that govern company expenditures by cardholders. Cardholder database 3230 facilitates the look-up of issuers 1500 and cardholder information; such information includes the cardholder's employer, spending history and analysis, and cardholder elite status (if any). Elite cardholder database 2240 is configured to store data and policies that an issuer 1300 or payment processor 2000 may enable for elite cardholders.

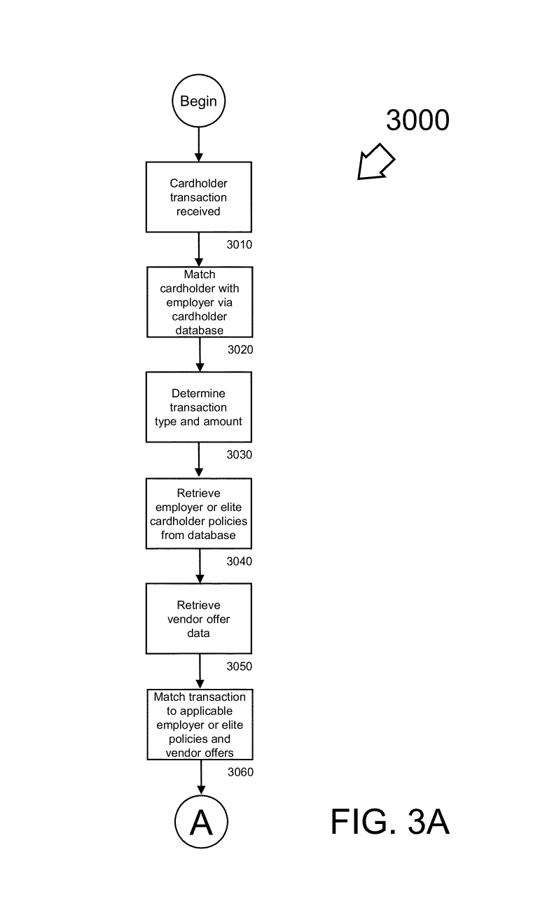

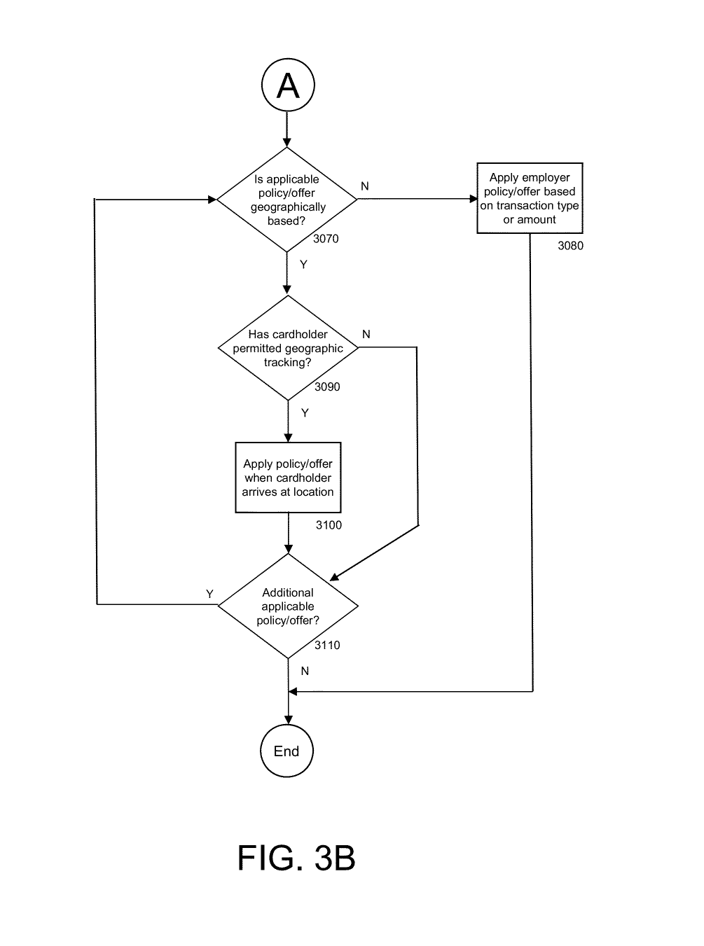

It is understood by those familiar with the art that one or more of these databases 2210-2240 may be combined in a myriad of combinations. The function of these structures may best be understood with respect to the flowcharts of FIGS. 3A-3B, as described below.

We now turn our attention to method or process embodiments of the present disclosure, FIGS. 3A-3B. It is understood by those known in the art that instructions for such method embodiments may be stored on their respective computer-readable memory and executed by their respective processors. It is understood by those skilled in the art that other equivalent implementations can exist without departing from the spirit or claims of the disclosure.

FIGS. 3A-3B flowchart a payment processor method 3000 embodiment to enable intelligent management of ancillary services related to expenses incurred on a payment card, constructed and operative in accordance with an embodiment of the present disclosure.

Method 3000 may be a real-time or batch method that facilitates employer policies, elite cardholder policies, and/or vendor offers based at least in part on cardholder spending. For illustrative purposes only, method 300 will be described as a real-time process, although it understood that a batch process embodiment may be implemented by some payment processors 2000.

Initially a cardholder payment transaction takes place with a vendor 1200. As part of the approval transaction process, vendor 1200 contacts payment processor 2000. In a real-time process, the transaction information may be directly forwarded to intelligent business management platform 2110 from payment-purchase engine 2130 via network interface 2300. In a batch process embodiment, payment-purchase engine 2130 may store the transaction in cardholder database 2230 for later analysis.

At block 3010, intelligent business management platform 2110 receives customer transaction information. The customer transaction information includes a cardholder's primary account number (PAN) and a transaction amount and type. In some embodiments, the customer transaction information may also include an indicator of the location of the transaction.

Using the primary account number, intelligent business management platform 2110 matches the cardholder with an employer via the cardholder database 2230, block 3020. The transaction type and amount are determined from the customer transaction information, block 3030.

At block 3040, intelligent business management platform 2110 retrieves the applicable employer policies and elite cardholder policies from employer policy database 2220 and elite cardholder policy database 2240. It is understood that some embodiments may retrieve both policies, while other embodiments may retrieve one or the other.

As mentioned previously, employer policy database 2220 is configured to store data and policies that govern company expenditures by cardholders. Policies may include useful travel information, restrictions on cardholder spending, and/or notifications/reminders for employees regarding company expenditures, or any other policies known in the art. For example, these policies may include negotiated rate alerts for hotels and restaurants, reminders to save receipts when expenses exceed a predetermined amount, and information such as flight, rail, dining or entertainment options, currency exchange or weather information. Policies may incorporate use of corporate expense management tools for better reporting, link travel information more easily to social networks, enable cardholders to obtain applicable corporate rates and travel preferences, and include loyalty-program account information. Policies may include notification preferences, allowing cardholder notifications via e-mail, short message service (SMS) or other text-message, social network, and automated voice options (such as telephone calls). For example, suppose the company has a policy preference for employees to take public transport. When a cardholder's flight arrives in London (as indicated by global positioning system (GPS) or travel itinerary data), the policy causes a notification to be sent to the cardholder, reminding the cardholder to take the London underground system instead of a taxi. For some embodiments, an elite policy may alert a customer representative (such as a concierge, travel agent or other professional) to call the cardholder as a form of notification or alert. For example, if a travel disruption occurs, and the employer or elite policy may have a travel agent call cardholders to inform them of the disruption and offer alternate transportation options.

Elite cardholder database 2240 is configured to store data and policies that an issuer 1300 or payment processor 2000 may enable for elite cardholders. Elite cardholder policies include similar policies to employer policy database 2220, without the company expenditure restrictions. Additionally elite cardholder policies may include special offers or conveniences to aid in cardholder satisfaction. For example, if a cardholder is traveling in a geographic location with special elite offers, they may receive a notification about the offer.

At block 3050, intelligent business management platform 2110 retrieves vendor offer data from a vendor offer database 2210. In some embodiments, vendor offers may overlap with elite cardholder offers. However, vendor offers are not restricted to cardholders with elite status, but may be offered to cardholders based on geography, type of previous purchase, time period or to all cardholders. Vendors 1200 may set any offer parameters known in the art for vendor offers.

Intelligent business management platform 2110 matches the transaction to applicable employer, elite policies, and/or vendor offers.

At decision block 3070, intelligent business management platform 2110 determines whether the applicable policy or offer is geographically based. If not, the policy or offer is applied based at block 3080. Note that policies and offers may have a variety of inputs. While the financial transaction may inform the intelligent business management platform 2110 of travel or other triggers, the transaction is only part of the data that the platform 2110 will use to cause a policy action. Other factors may include vendor offers, external information about trip interruptions, company request for communication to travelers, or even the date and time. The purchase of an air or rail ticket will often be the first piece of data that alerts the system that a trip is taking place and would then cause the platform 2110 to be on alert for other transactions that will signify the trip is occurring (and potentially locating the traveler) and scheduling communications based on policy and vendor offers at specified dates and times.

After the policy is implemented, process 3000 then ends.

If the applicable policy or offer is geographically based, the process flow continues at decision block 3070.

At decision block 3070, intelligent business management platform 2110 determines whether the cardholder has permitted geographic tracking. The cardholder may have opted into geographic tracking via a mobile phone or other mobile device, for example. In another example, employers may permit geographic tracking of an employee via an employer issued mobile phone.

If the cardholder has not permitted geographic tracking, the policy or offer is skipped, and the process flow continues at block 3110.

If the cardholder has permitted geographic tracking, the policy or offer is applied when the cardholder arrives at the geographic location, at block 3110.

At block 3110, intelligent business management platform 2110 determines whether any more applicable policies or offers exist. If so, the process flow returns to block 3070, otherwise process 3000 ends.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A payment processor method comprising:
receiving transaction data regarding a financial transaction, the transaction data including a Primary Account Number and a transaction type;
matching, with a processor, the Primary Account Number with an employer from a database;
retrieving an employer policy from the database;
determining whether the employer policy applies to the financial transaction; and,
executing, with the processor, the employer policy when the employer policy applies.

2. The method of claim 1 wherein the transaction data further includes an indicator of a location of the financial transaction.

3. The method of claim 2 wherein executing the employer policy includes a geographic location component.

4. The method of claim 2 wherein the executing includes notifying the cardholder via a network interface.

5. The method of claim 4 wherein the notifying includes a policy reminder.

6. The method of claim 1 wherein the transaction data is retrieved from the network interface.

7. The method of claim 1 wherein the transaction data is retrieved from a file.

8. The method of claim 3 further comprising:
matching the transaction data to an elite cardholder policy in the database; and,
applying the elite cardholder policy.

9. A payment network apparatus comprising:
a network interface configured to receive transaction data regarding a financial transaction, the transaction data including a Primary Account Number and a transaction type;
a processor configured to match the Primary Account Number with an employer from a database, to retrieve an employer policy from the database, to determine whether the employer policy applies to the financial transaction, and to execute the employer policy when the employer policy applies.

10. The apparatus of claim 9 wherein the transaction data further includes an indicator of a location of the financial transaction.

11. The apparatus of claim 10 wherein executing the employer policy includes a geographic location component.

12. The apparatus of claim 10 wherein the executing includes notifying the cardholder via the network interface.

13. The apparatus of claim 12 wherein the notifying includes a policy reminder.

14. The apparatus of claim 9 wherein the transaction data is retrieved from a file.

15. The apparatus of claim 11 wherein the processor is further configured to:
match the transaction data to an elite cardholder policy in the database; and,
apply the elite cardholder policy.

16. A non-transitory computer readable medium encoded with data and instructions, when executed by a computing device the instructions causing the computing device to:
receive transaction data regarding a financial transaction, the transaction data including a Primary Account Number and a transaction type;
match, with a processor, the Primary Account Number with an employer from a database;
retrieve an employer policy from the database;
determine whether the employer policy applies to the financial transaction; and,
execute, with the processor, the employer policy when the employer policy applies.

17. The non-transitory computer readable medium of claim 16 wherein the transaction data further includes an indicator of a location of the financial transaction.

18. The non-transitory computer readable medium of claim 17 wherein executing the employer policy includes a geographic location component.

19. The non-transitory computer readable medium of claim 17 wherein the executing includes notifying the cardholder via a network interface.

20. The non-transitory computer readable medium of claim 19 wherein the notifying includes a policy reminder.
